(19) United States
(12) Patent Application Publication
(10) Pub. No.: US 2026/0321218 A1
(43) Pub. Date: Oct. 15, 2026

(54) CONTROLLABLE SURFACE REFLECTANCE FOR VIEWING ENVIRONMENTS

(71) Applicant: DOLBY LABORATORIES LICENSING CORPORATION, San Francisco, CA (US)

(72) Inventor: Timo Daniel Kunkel, Kensington, CA (US)

(73) Assignee: DOLBY LABORATORIES LICENSING CORPORATION, San Francisco, CA (US)

(21) Appl. No.: 19/463,906

(22) Filed: Jan. 29, 2026

Related U.S. Application Data
(60) Provisional application No. 63/751,600, filed on Jan. 30, 2025.

(51) Int. Cl. G09G 3/34

(52) U.S. Cl. CPC G09G 3/344; G09G 2354/00; G09G 2360/16

(57) ABSTRACT

Systems and methods for adjustable wall reflectance within content viewing environments. One example provides a viewing environment including a content display configured to provide video content, a wall portion having an electrophoretic display, and a controller connected to the electrophoretic display. The controller configured to adjust a reflectivity of the electrophoretic display.

### CROSS-REFERENCE TO RELATED APPLICATIONS

This application claims priority to US provisional application 63/751,600, filed Jan. 30 2025 which is hereby incorporated by reference.

### BACKGROUND

### 1. Field of the Disclosure

This application relates generally to controllable object reflectance, and, more specifically, to controllable wall and surface reflectance encountered in spaces such as living rooms and theater environments.

### 2. Description of Related Art

Electronic paper, also referred to as intelligent paper or e-paper, is a display device that reflect ambient light to form spatially varying pattern such as gradients, geometric objects, words and images on a screen. In this manner, electronic paper displays provide an output differently from traditional flat-panel displays, commonly used in TVs or mobile phones, which actively emit light to form words and images. Electronic paper has a variety of uses, including e-books, wristwatches, smartphones, computer monitors, and the like.

### BRIEF SUMMARY OF THE DISCLOSURE

Ambient light is light from a light source that has been reflected by a reflective surface or object. Blackness can be described as areas that send less light to a viewers’ eyes compared to lighter areas. Ambient light reflects off black areas independent of them being emissive or reflective and increases the black levels of viewed pattern or images, impacting a stimulus’ perceived contrast composition and with that image fidelity and intended creator content. For example, in home viewing environments, light that is emitted from the display is also distributed in the viewing environment. When this emitted light impacts a wall or object, the light is reflected back, creating ambient light reflections and adding light onto the display. However, in home viewing environments, ambient light bounces may be desirable during normal living conditions where a bright ambiance is desirable. Currently, the type and magnitude of ambient light bounces cannot be dynamically controlled in a straightforward fashion.

Examples, aspects, and instances described herein provide the use of wall coverings with dynamically adjustable reflectivity. The reflectivity of the wall coverings may be adjusted temporally and spatially. For example, electrophoretic displays, such as electronic paper, may be implemented as wallpaper in a room. The use of an electrophoretic display provides for a dynamic reflectance of walls in the room such that a high reflectivity is provided during normal room use, while a low reflectivity is provided for content consumption (for example, while watching a movie).

Altering the reflectance of walls using an electrophoretic display provides several benefits and implementations. For example, the reflectance of the electrophoretic display may be tied to the content provided by a television. When the average picture level (APL) of the content increases above a threshold, the reflectance of the electrophoretic display is increased. Additionally, the reflectance of the electrophoretic display may be controlled based on characteristics of a viewing environment in which the electrophoretic display is installed. For example, the reflectance of the electrophoretic display may be altered to counter the point spread function (PSF) of lights within the viewing environment, to hide shadows, or hide corners, and the like.

Various aspects of the present disclosure relate to a viewing environment including a content display configured to provide video content, a wall portion having an electrophoretic display, and a controller connected to the content display and the electrophoretic display. The controller configured to adjust a reflectivity of the electrophoretic display.

In various other aspects the present disclosure relates to a method for controlling an electrophoretic display within a viewing environment, the method including receiving an average picture level (APL) value of video content displayed within the viewing environment and updating a reflectivity of the electrophoretic display based on the APL value.

In various other aspects the present disclosure relates to method for controlling an electrophoretic display within a viewing environment, the method including obtaining characteristics of the viewing environment, setting a reflectivity gradient of the electrophoretic display based on the characteristics of the viewing environment, controlling a content display to provide video content, and updating the reflectivity gradient of the electrophoretic display based on the displayed content.

In this manner, various aspects of the present disclosure provide for the implementation of electrophoretic displays within viewing environments, and effect improvements in at least the technical fields of image projection and emissive display, holography, signal processing, interior design, architecture and the like.

### DESCRIPTION OF THE DRAWINGS

These and other more detailed and specific features of various embodiments are more fully disclosed in the following description, reference being had to the accompanying drawings, in which:

FIG. 1 illustrates an example viewing environment during normal, non-content viewing use, according to some aspects of the disclosure herein.

FIG. 2 illustrates the viewing environment of FIG. 1 during content viewing, according to some aspects of the disclosure herein.

FIG. 3 is a block diagram of a control system for a viewing environment that includes electrophoretic displays, according to some aspects of the disclosure herein.

FIG. 4 is a block diagram of a control system for a multi-panel electrophoretic display, according to some aspects of the disclosure herein.

FIG. 5 illustrates another example viewing environment equipped with dynamically adjustable wall coverings during normal, non-content viewing use, according to some aspects of the disclosure herein.

FIG. 6 illustrates the viewing environment of FIG. 5 during content viewing, according to some aspects of the disclosure herein.

FIG. 7 illustrates a flow chart of a method for controlling an electrophoretic display based on whether content is being viewed on a content display, according to some aspects of the disclosure herein.

FIG. 8 illustrates a flow chart of a method for controlling an electrophoretic display based on the APL of content being displayed by a content display, according to some aspects of the disclosure herein.

FIG. 9 illustrates another example viewing environment during content viewing having a low APL, according to some aspects of the disclosure herein.

FIG. 10 illustrates the viewing environment of FIG. 9 during content viewing having a high APL, according to some aspects of the disclosure herein.

FIG. 11 illustrates an example of point spread function compensation using an electrophoretic display, according to some aspects of the disclosure herein.

FIG. 12 illustrates an example of shadow compensation using an electrophoretic display, according to some aspects of the disclosure herein.

FIG. 13A illustrates a top-down view of an example viewing environment, according to some aspects of the disclosure herein.

FIG. 13B illustrates a perspective view of the viewing environment of FIG. 13A without reflectivity compensation, according to some aspects of the disclosure herein.

FIG. 13C illustrates a perspective view of the viewing environment of FIG. 13B with reflectivity compensation, according to some aspects of the disclosure herein.

FIGS. 14A-14B illustrate another perspective view of a viewing environment, according to some aspects of the disclosure herein.

FIG. 15 illustrates another top-down view of a viewing environment, according to some aspects of the disclosure herein.

FIG. 16A illustrates an example lighting fixture projecting light with the direct surrounding electrophoretic display in a low-reflectivity mode, according to some aspects of the disclosure herein.

FIG. 16B illustrates an example lighting fixture projecting light with the direct surrounding electrophoretic display in a high-reflectivity mode, according to some aspects of the disclosure herein.

FIG. 17 illustrates example vector descriptors to transmit spatial information for an electrophoretic display, according to some aspects of the disclosure herein.

FIG. 18 illustrates a flow chart of a method for controlling an electrophoretic display, according to some aspects of the disclosure herein.

FIGS. 19A-19C illustrate a mechanical reflectance changing device in three different positions, according to some aspects of the disclosure herein.

### DETAILED DESCRIPTION

This disclosure and aspects thereof can be embodied in various forms, including hardware, devices, or circuits controlled by computer-implemented methods, computer program products, computer systems and networks, user interfaces, and application programming interfaces; as well as hardware-implemented methods, signal processing circuits, memory arrays, application specific integrated circuits (ASICs), field programmable gate arrays (FPGAs), and the like. The foregoing summary is intended solely to give a general idea of various aspects of the present disclosure, and does not limit the scope of the disclosure in any way.

In the following description, numerous details are set forth, such as optical device configurations, timings, operations, and the like, in order to provide an understanding of one or more aspects of the present disclosure. It will be readily apparent to one skilled in the art that these specific details are merely examples and not intended to limit the scope of this application.

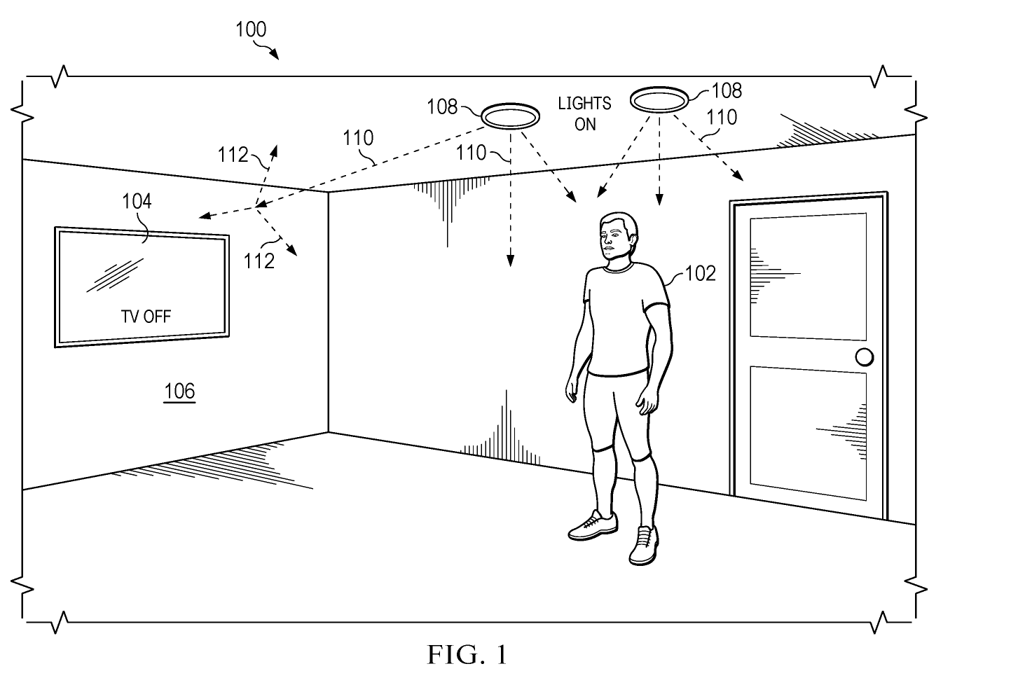

Ambient light is light from a light source that has been reflected by a reflective surface or object. Many apartment owners and homeowners decorate their walls and living spaces with reflective surfaces, such as reflective paint and furniture (e.g., tables, couches, etc.). These reflective surfaces diffuse incoming light (e.g. from a light source such as the sun or a lamp), dispersing ambient light through the room. Light may be reflected and dispersed multiple times depending on the reflectivity properties in the environment, such as the albedo of walls and objects. For example, high-reflectivity walls and furniture with white or other light colors avoid harsh shadows in a room and are typically desirable for everyday activities. FIG. 1 illustrates an example environment 100 (e.g., a living room) that includes an observer 102, a content display 104 (e.g., a television, a projector projecting images onto a wall or screen, etc.), reflective surfaces 106 (e.g., walls), and lighting fixtures 108. In the example of FIG. 1, the content display 104 is off and does not emit light, while the lighting fixtures 108 do emit light beams 110. At least a portion of the light beams 110 are reflected by the reflective surfaces 106 as reflected light beams 112. The reflected light beams 112 disperse within the environment 100 such that the environment 100 is evenly lit.

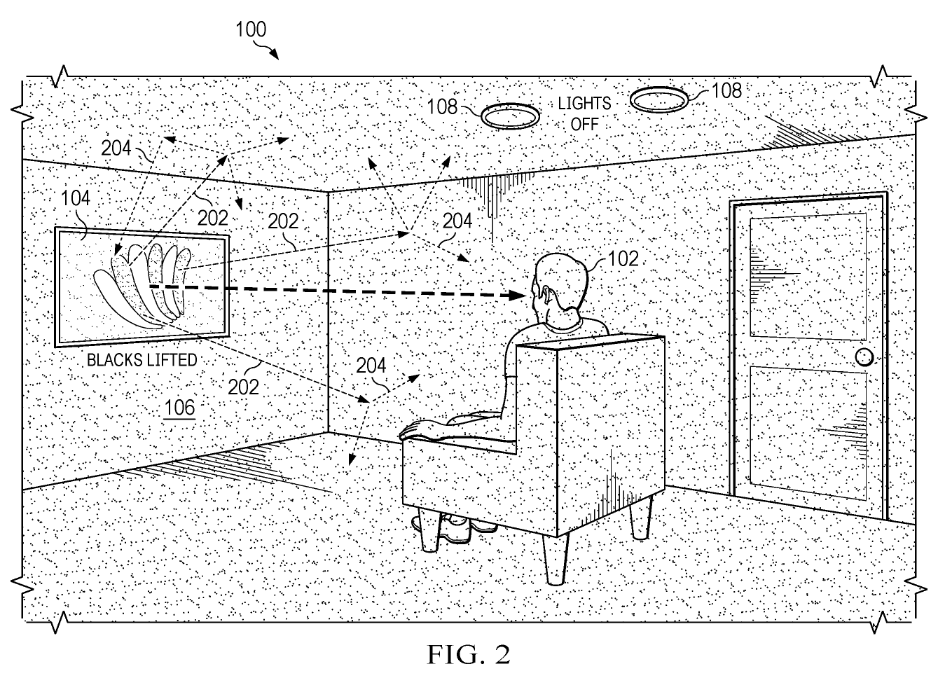

However, in many situations, the lighting fixtures 108 are turned off and the content display 104 is turned on to consume content from the content display 104. However, light emitted from the content display 104 is also reflected by the reflective surfaces 106. For example, FIG. 2 illustrates the environment 100 when the content display 104 is emitting light and the lighting fixtures 108 are turned off. The content display 104 emits light beams 202. Due to the high albedo of reflective surface 106, a noticeable portion of the light beams 202 are reflected as reflected light beams 204. Additionally, at least a portion of the reflected light beams 204 may be reflected back onto the content display 104. The reflected light beams 204 are undesirable, as the reflected light beams 204 increase the black levels of the image provided by the content display 104.

Additionally, the observer 102 may choose to keep at least a portion of the lighting fixtures 108 on to emit light in addition to the content display 104, further raising the diffuse ambient light. The ambient light, alongside reflections and dispersions off the reflective surfaces 106, the picture quality of the displayed content can deteriorate and/or be negatively impacted (e.g., by further lifting the black levels of the content display 104).

Examples described herein provide for the use of surfaces having adjustable reflectivity (e.g., reflectance). For example, the reflective surfaces 106 within the environment 100 may be electrophoretic displays (e.g., electronic paper or e-paper). The electrophoretic displays may be provided as wallpaper on the reflective surfaces 106. The electrophoretic displays may be dynamically adjustable such that the reflectivity of the electrophoretic displays may be adjusted both temporally and spatially. For example, the electrophoretic displays may be adjusted based on whether the content display 104 is emitting light, based on the video content displayed by the content display 104, based on metadata associated with the video content, based on other features or objects within the environment 100, or the like.

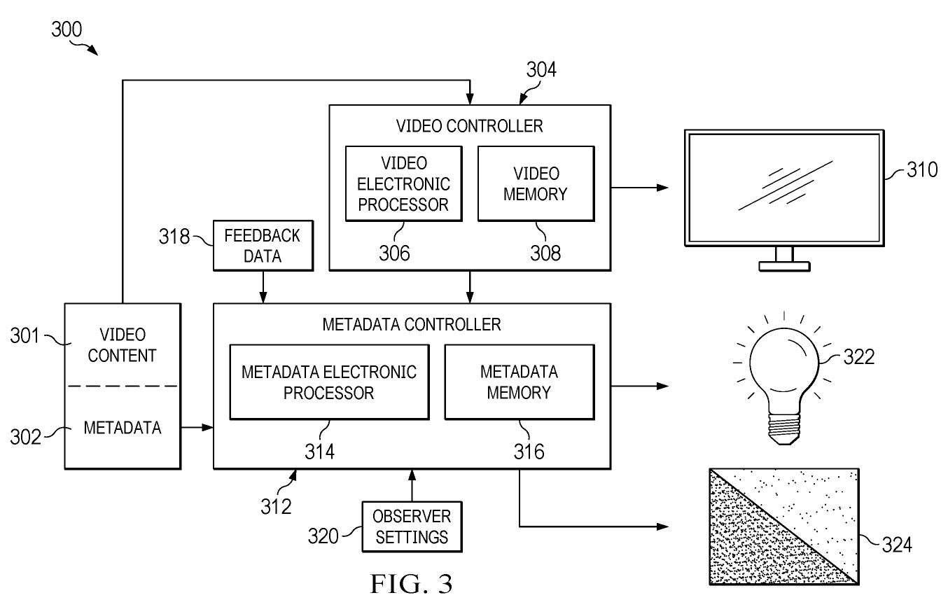

FIG. 3 is a block diagram of a control system 300 for a viewing environment that includes electrophoretic displays, according to some examples described herein. The control system 300 includes video content 301, metadata 302, a video controller 304, a content display 310, a metadata controller 312, feedback data 318, observer settings 320, a lighting fixture 322, and an electrophoretic display 324. The video content 301 may be received simultaneously with the metadata 302 (for example, in a shared packet or series of packets from the same source) or may be received separately from the metadata 302 (for example, from a difference source). The metadata 302 may be associated with the video content 301. For example, the metadata 302 may include information to assist with processing the video content 301. The metadata 302 may also include information describing the content defined by the video content 301, such as luminance levels, color gradients, and the like. In some instances, the metadata 302 includes information for controlling the electrophoretic display 324, as described below in more detail.

The video controller 304 receives the video content 301. In some instances, the video controller 304 also receives the metadata 302. The video controller 304 includes a video electronic processor 306 and a video memory 308. The video electronic processor 306 and the video memory 308 may communicate over one or more control and/or data buses. FIG. 3 illustrates only one example of the video controller 304, and the video controller 304 may include more or fewer components and may perform functions other than those explicitly described herein. In some examples, the video electronic processor 306 is implemented as a microprocessor with separate video memory 308. In other examples, the video electronic processor 306 is implemented as a microcontroller, where the video memory 308 is on the same chip. The video electronic processor 306 may be implemented with multiple processors, and may be implemented partially or entirely as, for example, a field-programmable gate array (FGPA) or an applications specific integrated circuit (ASIC).

The video memory 308 includes non-transitory, computer-readable memory that stores instructions that are received and executed by the video electronic processor 306 to carry out functionality of the content display 310 described herein. The video memory 308 may include, for example, combinations of different types of memory, such as read-only memory and random-access memory. The instructions stored by the video memory 308 may include instructions for processing the video content received by the video controller 304. The video controller 304 may provide processed video content via the content display 310.

The metadata controller 312 receives the metadata 302. In some instances, the metadata controller 312 also receives the video content 301. The metadata controller 312 includes a metadata electronic processor 314 and a metadata memory 316. The metadata electronic processor 314 and the metadata memory 316 may communicate over one or more control and/or data buses. FIG. 3 illustrates only one example of the metadata controller 312, and the metadata controller 312 may include more or fewer components and may perform functions other than those explicitly described herein. In some examples, the metadata electronic processor 314 is implemented as a microprocessor with separate metadata controller 312. In other examples, the metadata electronic processor 314 is implemented as a microcontroller, where the metadata memory 316 is on the same chip. The metadata electronic processor 314 may be implemented with multiple processors, and may be implemented partially or entirely as, for example, a field-programmable gate array (FGPA) or an applications specific integrated circuit (ASIC).

The metadata memory 316 includes non-transitory, computer-readable memory that stores instructions that are received and executed by the metadata electronic processor 314 to carry out functionality of the lighting fixture 322 and the electrophoretic display 324 described herein. The metadata memory 316 may include, for example, combinations of different types of memory, such as read-only memory and random-access memory. The instructions stored by the metadata memory 316 may include instructions for controlling the lighting fixture 322 and/or the electrophoretic display 324 based on the metadata 302 received by the metadata controller 312, as described below in more detail.

In some examples, the metadata controller 312 also receives feedback data 318. The feedback data 318 may be data indicative of current environment ambient levels, properties of the lighting fixture 322 within the environment, material properties of the electrophoretic display 324, and the like. The feedback data 318 may be provided by the lighting fixture 322 and/or the electrophoretic display 324, or by other components within the control system 300 that are not explicitly shown, such as a camera, light sensors, or the like. By way of example, a camera may track a current state (e.g., reflectivity values) of the electrophoretic display 324, such as a speed, intensity, and effectiveness of the reflectivity of the electrophoretic display 324. The camera may be a smart phone camera. The camera may provide a signal to the metadata controller 312 as part of the feedback data 318 that is indicative of the state of the electrophoretic display 324. In other instances, the metadata controller 312 receives images and/or video from the camera and determines the state of the electrophoretic display 324 based by performing image and/or video analysis on the input from the camera.

In a further example, the feedback data 318 is provided by a single pixel color sensor (for example, a colorimeter) that scans the reflectance of a surface (e.g., the electrophoretic display 324). Additionally, a single pixel-wide directional sensor may be implemented to identify the ambient reflectance properties by emitting a known light source into the room and then changing wall properties of the electrophoretic display 324. For example, a dark patch is created by the electrophoretic display 324 (based on control signals from the metadata controller 312) from one side of the room to another while measuring the ambient luminance progression. This may assist in hot-spot mitigation to remove light that bounces directly towards the content display 310.

In yet a further example, a room environment may be scanned, for example, with a mobile phone, to identify the spatial position of content displays and light sources in relation to the electrophoretic display 324 (e.g., position, surface normal, contrast properties, reflectivity, and other relations). The scanned room environment may be provided as part of the feedback data 318 and may establish a spatial albedo map of the environment for use by the metadata controller 312.

The metadata controller 312 may also receive observer settings 320 that are indicative of a viewer’s personalized preferences. In some instances, the observer settings 320 includes provided or determined viewing habits of the observer 102. The observer settings 320 and/or the feedback data 318 may also include details regarding the environment, such as the location (e.g., coordinates) of objects within the environment, a dimension of the environment, the location of lighting fixtures and other lighting devices within the environment, and the like.

While described separately, in some implementations, the video controller 304 and the metadata controller 312 may be combined into a single controller to perform the operations described herein. In other implementations, additional controllers separate from the video controller 304 and the metadata controller 312 may be provided within the control system 300 to perform the operations described herein.

The electrophoretic display 324 may be only a single electrophoretic display 324 or may be a combination of several panels of electrophoretic displays 324. Additionally, the electrophoretic display 324 may include a single processor that controls every panel forming the electrophoretic display 324, or every panel may include its own processor (e.g., an edge processor). The processor of the electrophoretic display 324 changes the state of the electrophoretic display 324 based on control signals from the metadata controller 312.

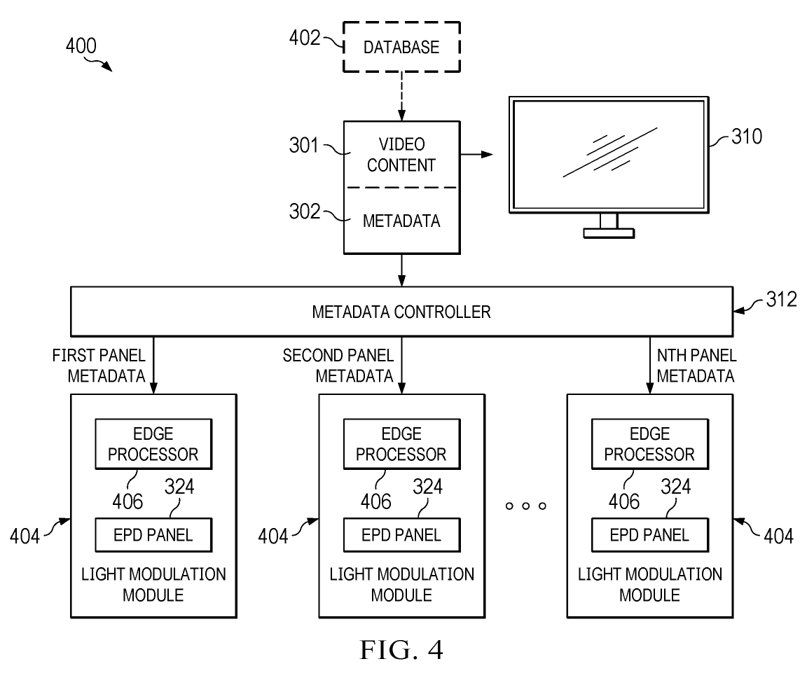

For example, FIG. 4 is a block diagram of a control system 400 for a multi-panel electrophoretic display 324. The control system 400 may be substantially similar to the control system 300 with components (e.g., the video controller 304, the lighting fixture 322, the feedback data 318, the metadata controller 312) omitted for clarity. The example control system 400 of FIG. 4 includes the electrophoretic display 324 split into multiple panels integrated into respective light modulation modules 404. A respective edge processor 406 is included in each light modulation The metadata 302 may indicate the APL of the video content 301. The metadata controller 312 controls the electrophoretic display 324 based on the APL of the video content 301. By way of example, when the displayed content from the content display 310 is dark (e.g., a low APL), the electrophoretic display 324 is controlled to have a low reflectivity. When the displayed content from the content display 310 is bright (e.g., a high APL), the electrophoretic display 324 is controlled to have high reflectivity. module 404. The metadata controller 312 receives the metadata 302. The metadata controller 312 provides data, such as the metadata 302, to each respective light modulation modules 404 independently such that the respective edge processor 406 drives the respective electrophoretic display 324 panel.

In some instances, the control system 400 includes a database 402 configured to provide the video content 301 and the metadata 302. The metadata controller 312 may process the metadata 302 and generate individual controls for each respective light modulation module 404.

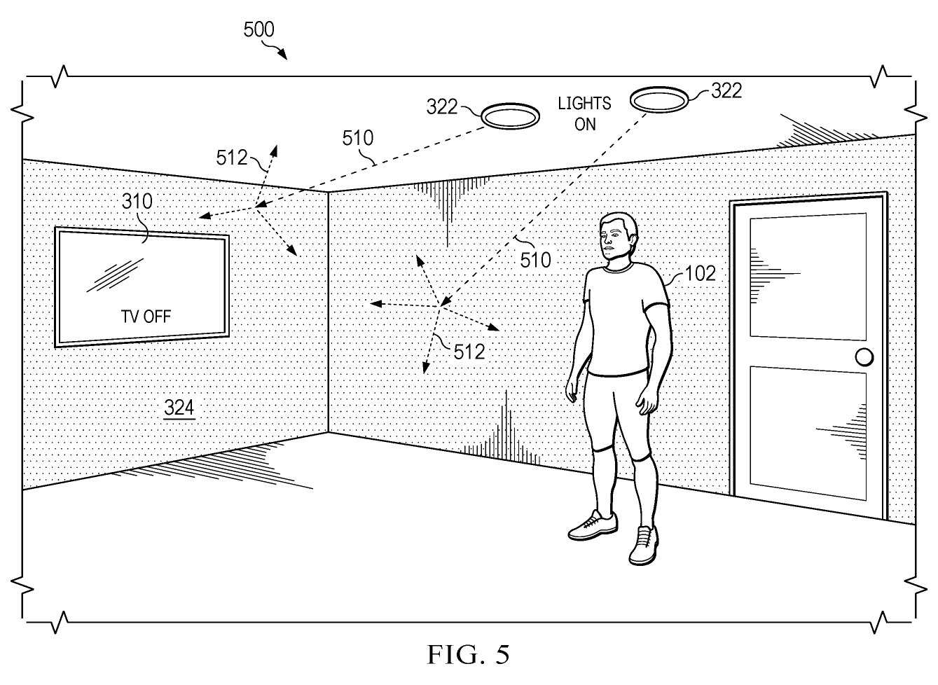

The electrophoretic display 324 may be implemented within an environment, such as a living room, to have bright, reflective walls during normal activity and dark, non-reflective walls when watching content on the content display 310. For example, FIG. 5 illustrates an environment 500 (e.g., a living room) that includes the observer 102, the content display 310, the electrophoretic display 324, and one or more lighting fixtures 322. In the example of FIG. 5, the environment 500 is configured to normal activity (e.g., non-content viewing activity). The electrophoretic display 324 is configured as wallpaper on the walls of the environment 500. In the example of FIG. 5, the electrophoretic display 324 is set to a high reflectivity. For example, the lighting fixture 322 projects light beams 510. The electrophoretic display 324 reflects the light beams 510 as reflected light beams 512.

In some instances, the observer 102 may set the reflectivity of the electrophoretic display 324 to low reflectivity. For example, the environment 500 may include a light switch that changes the reflectivity of the electrophoretic display 324. When the light switch is in a first position, the metadata controller 312 controls the electrophoretic display 324 to a low-reflectivity mode. When the light switch is in a second position, the metadata controller 312 controls the electrophoretic display 324 to a high-reflectivity mode. In another example, the electrophoretic display 324 is controlled by a remote that sets or changes the reflectivity of the electrophoretic display 324.

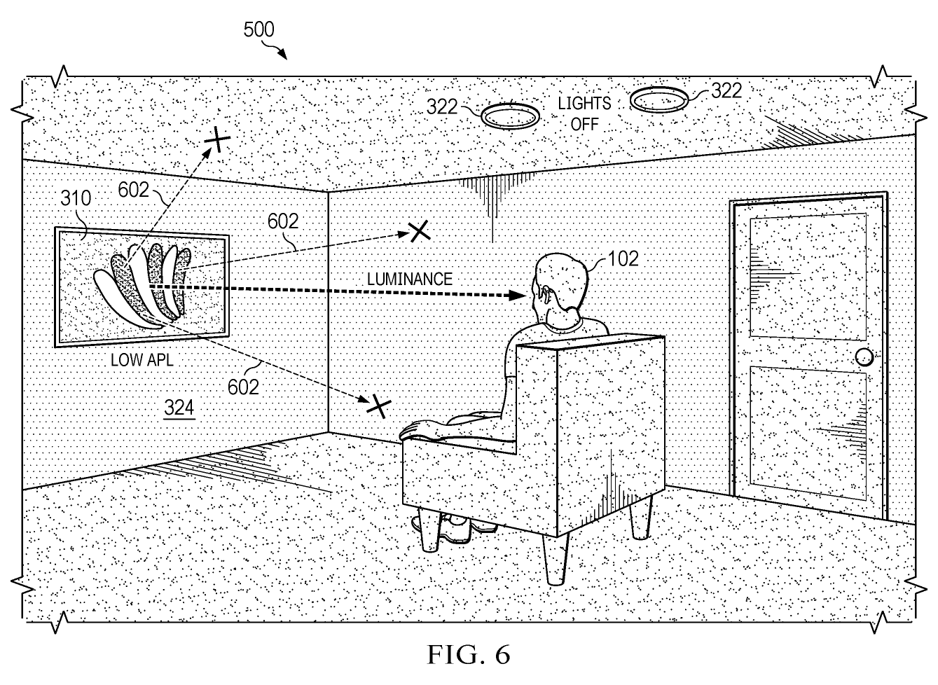

FIG. 6 illustrates the environment 500 configured in a low-reflectivity setting. In the example of FIG. 6, the lighting fixtures 322 are off and do not emit light. The content display 310 is on to display and image. The electrophoretic display 324 is configured for low reflectivity. Accordingly, while the content display 310 emits light beams 602, the electrophoretic display 324 does not significantly reflect the light beams 602 and instead absorbs the light beams 602.

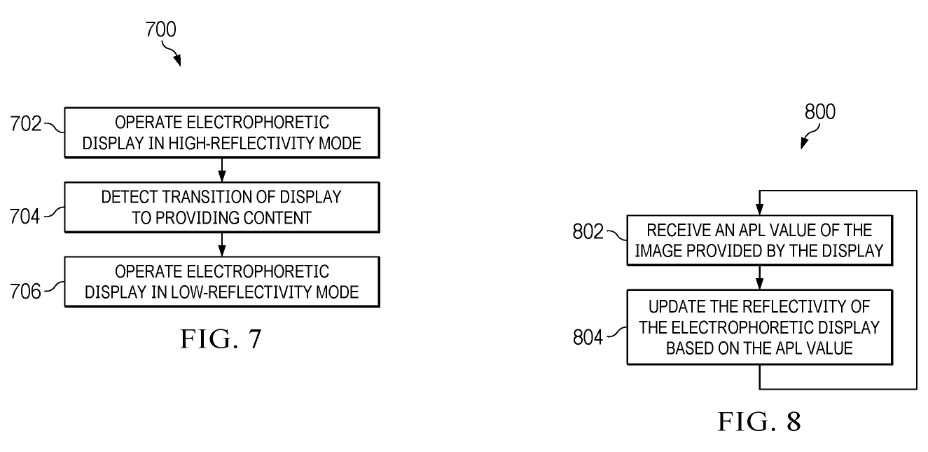

FIG. 7 provides a flow chart of a method 700 for controlling the electrophoretic display 324 based on whether content is being viewed on the content display 310. The method 700 may be performed by, for example, the metadata controller 312. In some instances, the method 700 may be performed by the metadata controller 312 in conjunction with the video controller 304. Additionally, the steps provided within FIG. 7 are merely examples, and may instead be conducted in a different order.

At step 702, the metadata controller 312 operates the electrophoretic display 324 in a high-reflectivity mode. For example, the environment 500 is configured for normal activity, and content is not being viewed on the content display 310.

At step 704, the metadata controller 312 detects a transition of the content display 310 to providing content. For example, the content display 310 begins displaying content for view by the observer 102. In some instances, the metadata controller 312 receives an input from, for example, a light switch, a remote control, or the like.

At step 706, the metadata controller 312 operates the electrophoretic display 324 in a low-reflectivity mode. For example, the metadata controller 312 changes the reflectivity of the electrophoretic display 324 to low reflectivity in response to the transition of the content display 310.

In some implementations, rather than adjusting the reflectivity of the electrophoretic display 324 to either a high reflectivity setting or a low reflectivity setting based on whether content is being viewed, the reflectivity of the electrophoretic display 324 may be dynamically set based on the average picture level (APL) (e.g., brightness, intensity) of the content being viewed. In examples described herein, “low APL” may refer to images having an APL value below an arbitrary or example APL threshold, while “high APL” may refer to images having an APL value above the APL threshold. In other or similar examples, “high APL” may refer to images having a contrast perceivably worse than images having “low APL”.

The metadata 302 may indicate the APL of the video content 301. The metadata controller 312 controls the electrophoretic display 324 based on the APL of the video content 301. By way of example, when the displayed content from the content display 310 is dark (e.g., a low APL), the electrophoretic display 324 is controlled to have a low reflectivity. When the displayed content from the content display 310 is bright (e.g., a high APL), the electrophoretic display 324 is controlled to have high reflectivity.

FIG. 8 provides a method 800 for controlling the electrophoretic display 324 based on the APL of content being displayed by the content display 310. The method 800 may be performed by, for example, the metadata controller 312. In some instances, the method 800 may be performed by the metadata controller 312 in conjunction with the video controller 304. Additionally, the steps provided within FIG. 8 are merely examples, and may instead be conducted in a different order.

At block 802, the metadata controller 312 receives an APL value of the image provided by the content display 310. For example, the APL value for a given frame or series of frames in the video content 301 may be included in the metadata 302 that is received by the metadata controller 312. In another example, the environment 500 includes a light sensor that detects the brightness of light emitted by the content display 310. The metadata controller 312 receives a signal from the light sensor indicative of the brightness and determines an APL value of the image based on the brightness. In some instances, the light sensor detects a total brightness of light present within an environment (for example, the light emitted by the content display 310 combined with ambient light within a room), or detects only ambient light within the environment.

At block 804, the metadata controller 312 updates the reflectivity of the electrophoretic display 324 based on the APL value. For example, the metadata memory 316 may store a look-up table that relates various APL values to a reflectivity value. In another example, the metadata memory 316 stores a function that, when provided an APL value, outputs a corresponding reflectivity value. In yet another example, the metadata memory 316 stores a plurality of thresholds. The reflectivity of the electrophoretic display 324 is set by the metadata controller 312 based on the relationship between the APL value and the plurality of thresholds. For example, when the APL value is greater than or equal to a first threshold but less than a second threshold, the reflectivity of the electrophoretic display 324 is set to a first value. When the APL value is greater than or equal to the second threshold but less than a third threshold, the reflectivity of the electrophoretic display 324 is set to a second value. In these examples, the reflectivity of the electrophoretic display 324 is set by the metadata controller 312 based on the APL value. The metadata controller 312 may return to block 802 such that the reflectivity of the electrophoretic display 324 is updated constantly (for example, at a set time interval) while viewing content on the content display 310 (for example, is updated each frame, is updated every other frame, or the like).

In some implementations, the metadata controller 312 also controls lighting devices within the environment 500 based on the APL of content displayed by the content display 310, such as the lighting fixture 322. For example, the lighting fixture 322 may be turned on by the metadata controller 312 to emit light when the APL of the image displayed by the content display 310 is high.

Examples described herein primarily refer to altering the reflectance of the electrophoretic display 324 based on the APL of content displayed by the content display 310. However, in some other examples, other statistical or otherwise derived values may be used to modify the reflectance of the electrophoretic display 324, such as the contrast of the content, the luminance of the content, a color value of the content, a total brightness within the viewing environment, and the like.

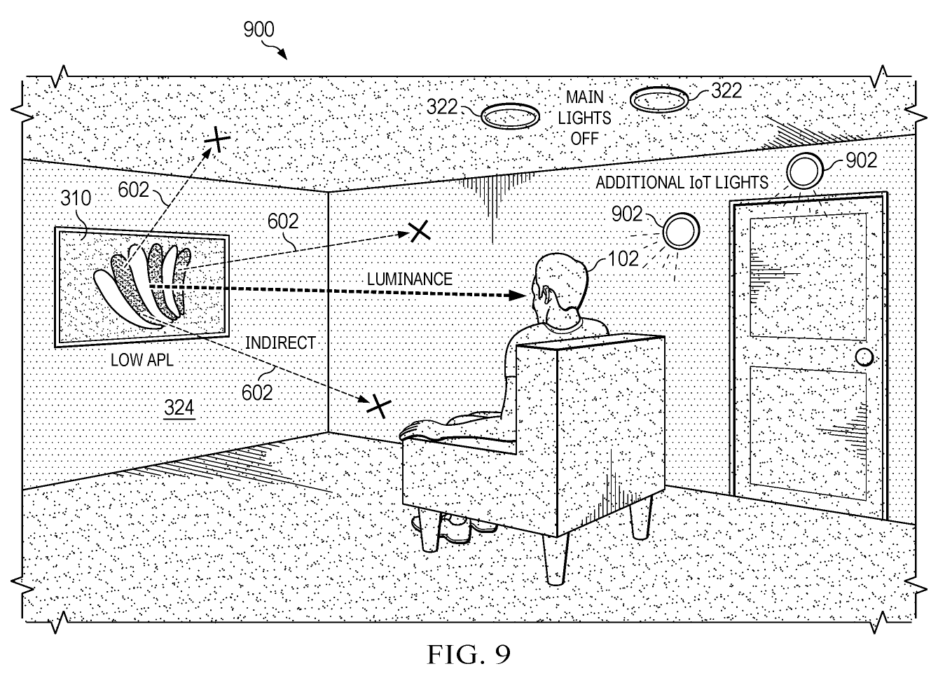

FIG. 9 illustrates an example environment 900 that includes the content display 310, the lighting fixture 322, and the electrophoretic display 324 when the content display 310 is displaying an image having a low APL value. The environment 900 also includes additional controllable lights 902. The controllable lights 902 may be, for example, dimmable lights, smart lights (for example, Internet-of-Things (IoT) lights), dimmable smart lights, or the like. The additional controllable lights 902 may be connected (e.g., by wired or wireless connection) to the metadata controller 312. When the APL value is low, the metadata controller 312 controls the lighting fixture 322 to an off state. The additional controllable lights 902 may be controlled by the metadata controller 312 to an off state or a dimmed state. In the example of FIG. 9, the electrophoretic display 324 has low reflectivity. At least a portion of the light beams 602 from the content display 310 may not be reflected by the electrophoretic display 324, and instead may be absorbed by the electrophoretic display 324.

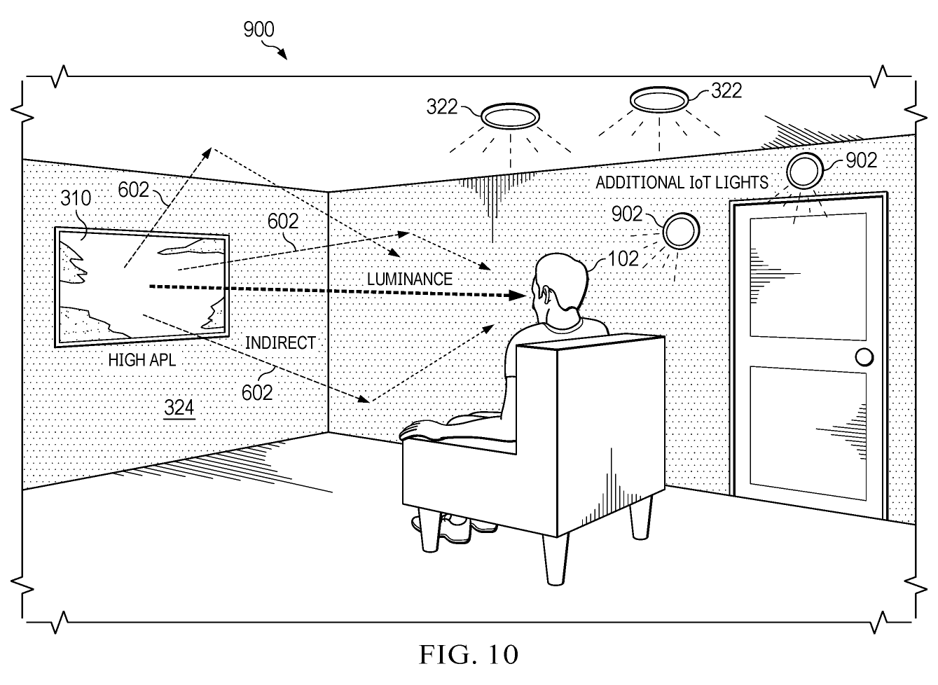

FIG. 10 illustrates the environment 900 when the content display 310 is displaying an image having a high APL value. In the example of FIG. 10, when the APL value is high, the metadata controller 312 controls the lighting fixture 322 to an on state. The additional controllable lights 902 may also be controlled by the metadata controller 312 to an on state. In the example of FIG. 10, the electrophoretic display 324 has a high reflectivity. The light beams 602 from the content display 310 are reflected by the electrophoretic display 324, adding reflected light to the environment 900.

In some implementations, the electrophoretic display 324 may be capable of changing colors. In such an implementation, the metadata controller 312 may also control the color of the electrophoretic display 324 to supplement or match the color of the image displayed by the content display 310 in addition to controlling the reflectivity of the electrophoretic display 324 based on the APL of the image displayed by the content display 310.

In some examples, the reflectivity of the electrophoretic display 324 may be spatially altered such that different areas of the electrophoretic display 324 have a different reflectivity value. For example, the reflectivity of the electrophoretic display 324 may be implemented as a gradient varying across the area of the electrophoretic display 324. By way of example, the portion of the electrophoretic display 324 immediately surrounding of the content display 310 may have a low reflectivity such that the area around the content display 310 is darker. The reflectivity of the electrophoretic display 324 may then gradually increase further from the content display 310. Accordingly, the electrophoretic display 324 may absorb immediate ambient light emitted from the content display 310 while allowing more reflectance further away, maintaining a base level of ambient light within the environment.

The reflectivity gradient may also be implemented near active light sources (e.g., the lighting fixture 322) or other sources of ambient light, such as windows. For example, the electrophoretic display 324 may be controlled by the metadata controller 312 to counter the Point Spread Function (PSF) of a light source (for example, a light bulb). The PSF of a light source is the natural spread of light from the light source, such as the light spread onto the electrophoretic display 324. FIG. 11 illustrates an example of the lighting fixture 322 without PSF compensation (in example 1100) and an example of the lighting fixture 322 with PSF compensation (in example 1110). In the example 1100, the lighting fixture 322 has a PSF 1102 onto the electrophoretic display 324. As the electrophoretic display 324 does not have any PSF compensation and is, instead, constant, the PSF 1102 is not impacted by the electrophoretic display 324.

However, in the example 1110, the electrophoretic display 324 does provide PSF compensation. For example, the lighting fixture 322 emits light that includes the PSF 1102. The PSF 1102 may be known by the metadata controller 312 (e.g., stored in the metadata memory 316), may be provided to the metadata controller 312 as part of the feedback data 318 or the observer settings 320, may be detected by a light sensor or camera included in the environment, or the like. The metadata controller 312 controls the electrophoretic display 324 to offset the PSF 1102 by changing the reflectivity of the electrophoretic display 324 around the lighting fixture 322 to be the negative, or opposite, of the PSF 1102 (represented as negative PSF 1112). Accordingly, the combined result of the PSF 1102 and the negative PSF 1112 is a combined PSF 1114 around the lighting fixture 322, which is reduced in intensity compared to the PSF 1102.

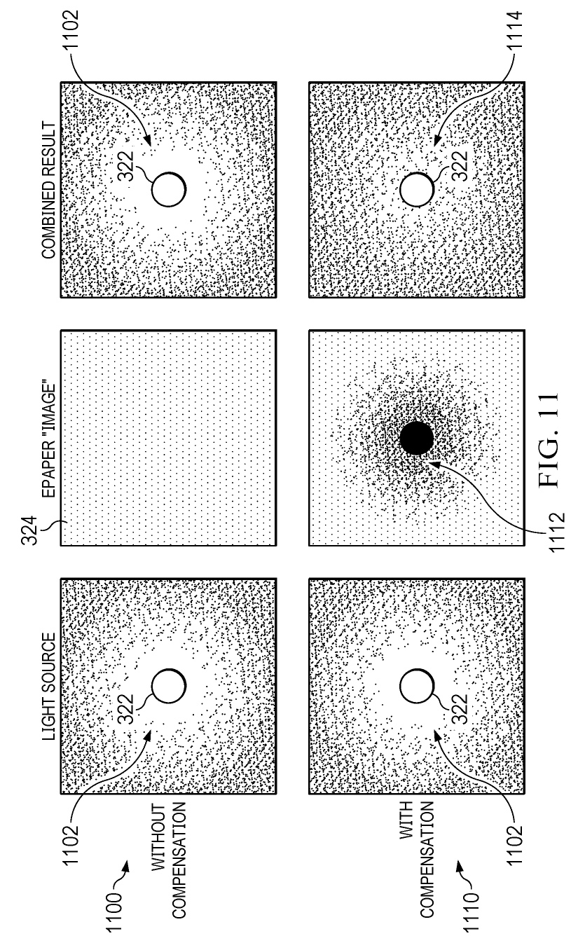

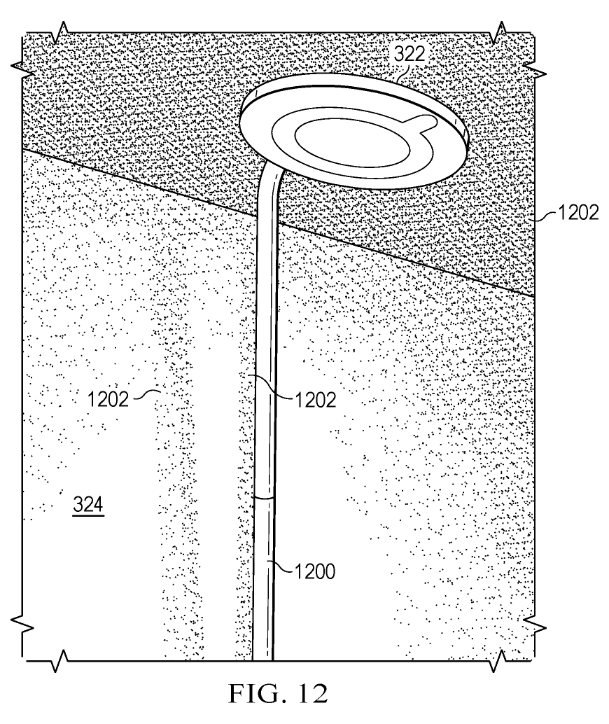

The electrophoretic display 324 may also be controlled to compensate for shadows that are located on the electrophoretic display 324. While examples thus far have provided the lighting fixture 322 as a ceiling fixture, the lighting fixture 322 (or another lighting device) may be a lamp or a similar lighting device. FIG. 12 illustrates such an example where the lighting fixture 322 is configured as a lamp. The lighting fixture 322 includes a pole 1200. Light from the lighting fixture 322 causes the pole 1200 to project shadows onto the electrophoretic display 324. The electrophoretic display 324 may be controlled by the metadata controller 312 to increase reflectivity or decrease reflectivity around the shadow of lighting fixture 322 to visually remove the shadows 1202. The changes in reflectivity of the electrophoretic display 324 may follow gradients that match the gradients of the shadows, therewith reducing the saliency of the shadows 1202. In some examples, light sensors are embedded within the electrophoretic display 324 to detect whether light (and therefore, shadows) is contacting the electrophoretic display 324. In other examples, cameras may be provided for capturing the distribution of shadows in the viewing environment. Both the light sensors and cameras may provide feedback to the metadata controller 312 as part of the feedback data 318.

Other aspects of the environment, such as corners within a room and furniture (including furniture corners) may also impact the travel of light within the environment due to their reflective nature. Accordingly, the metadata controller 312 may also alter the reflectivity of the electrophoretic display 324 to account of visual differences on the electrophoretic display 324 due to environmental features. By way of example, a corner area may cause a higher reflectance than the remaining wall due to the different incident angle of the incoming light. The reflectivity of the electrophoretic display 324 may be controlled to visually “hide” the corner or edge portion of a wall.

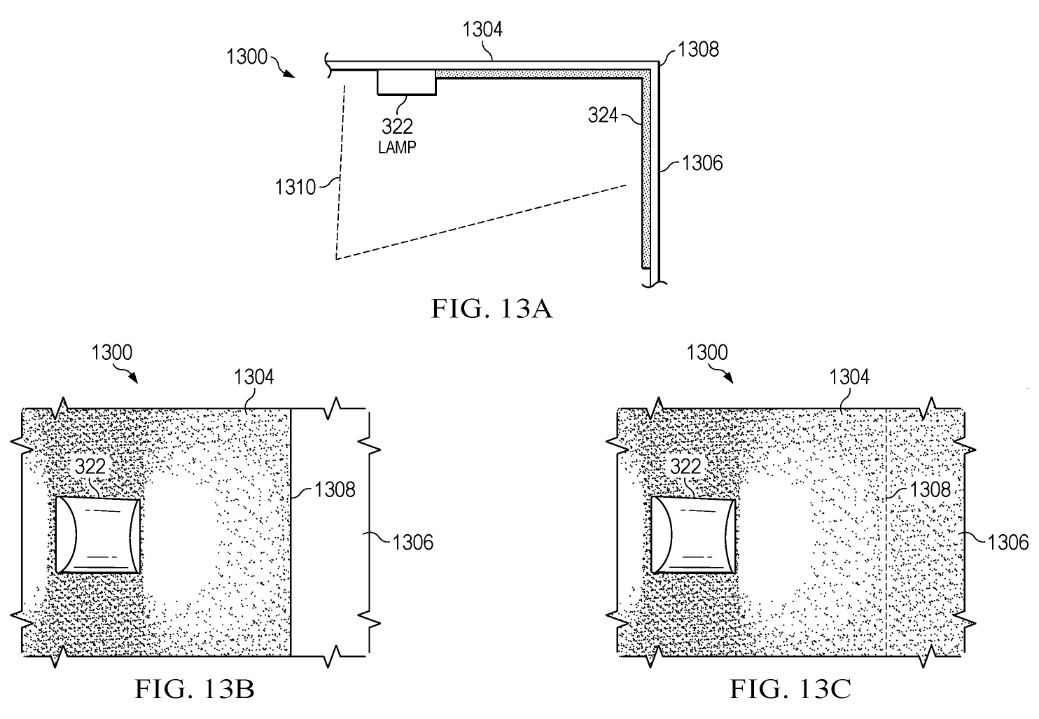

For example, FIG. 13A illustrates a top-down view of an environment 1300 including a lighting fixture 322 (e.g., a lamp) and a wall, which includes the electrophoretic display 324. The wall includes a first wall portion 1304 and a second wall portion 1306 connected by a corner 1308. FIG. 13B illustrates the environment 1300 from a point of view 1310 with no reflectivity compensation from the electrophoretic display 324. FIG. 13C illustrates the environment 1300 from the point of view 1310 with reflectivity compensation from the electrophoretic display 324.

As seen in FIG. 13B, light from the lighting fixture 322 emits directly onto the second wall portion 1306, causing the second wall portion 1306 to be brighter than the first wall portion 1304 and causing the corner 1308 to be visible. In FIG. 13C, the metadata controller 312 controls the electrophoretic display 324 to have a lower reflectivity in the second wall portion 1306, causing the electrophoretic display 324 to absorb more light. Accordingly, the first wall portion 1304 and the second wall portion 1306 are more visibly even in brightness, and the corner 1308 is visibly hidden due to a lack of contrast between the first wall portion 1304 and the second wall portion 1306. Hiding shadows and features within environments may assist with increasing immersion for the observer 102 viewing content on the content display 310.

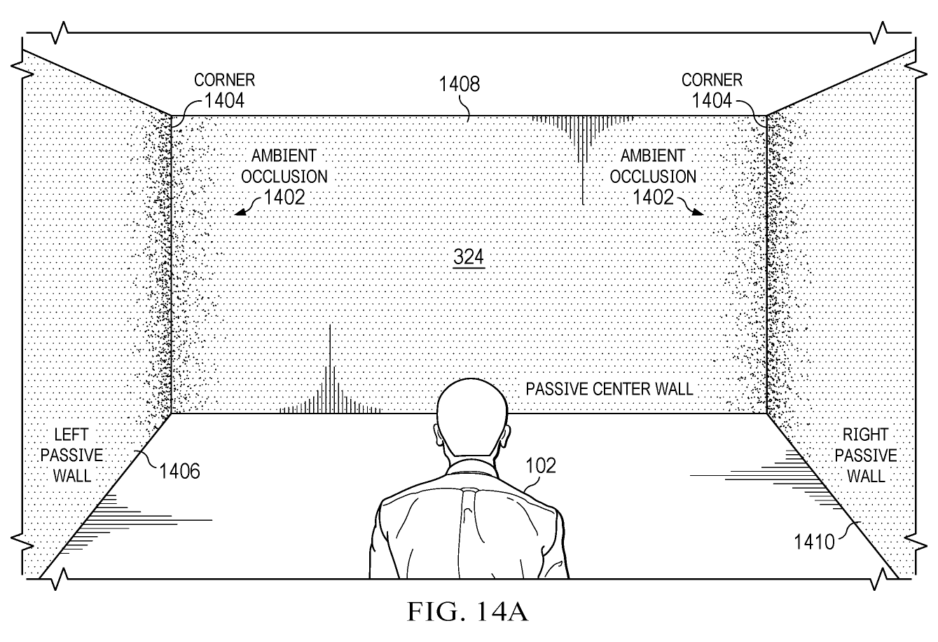

FIGS. 14A-14B illustrate another example environment 1400 including the electrophoretic display 324 covering a left wall 1406, a center wall 1408, and a right wall 1410. In FIG. 14A, as the observer 102 observes the electrophoretic display 324, corners 1404 and ambient occlusion 1402 resulting from the corners 1404 are visibly apparent to the observer 102. Accordingly, the metadata controller 312 may control the electrophoretic display 324 to adjust the reflectivity in the electrophoretic display 324, visibly hiding the corners 1404 and ambient occlusion 1402 from the view of the observer 102.

The metadata controller 312 may also control the reflectivity of the electrophoretic display 324 to enable perspective mapping effects. For example, the metadata controller 312 may track the view of the observer 102 (for example, via head tracking as understood by one skilled in the art). The metadata controller 312 may receive the view of an environment from the perspective of the observer 102 and control the electrophoretic display 324 to cause features within the environment (e.g., corners, ceilings, shelving, furniture, pictures, etc.) to optically disappear by eliminating sharp, abrupt gradient changes that may be caused by edges.

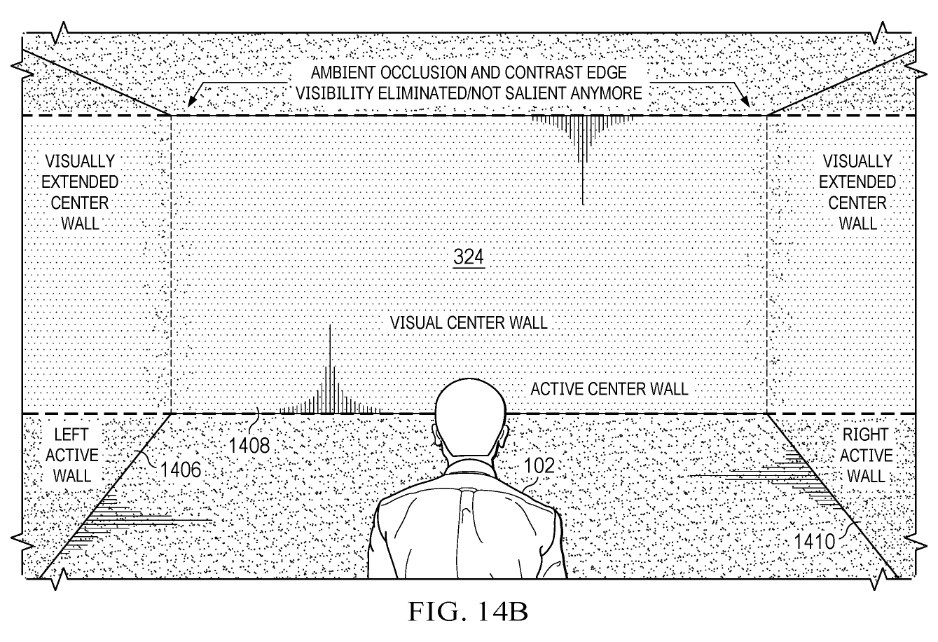

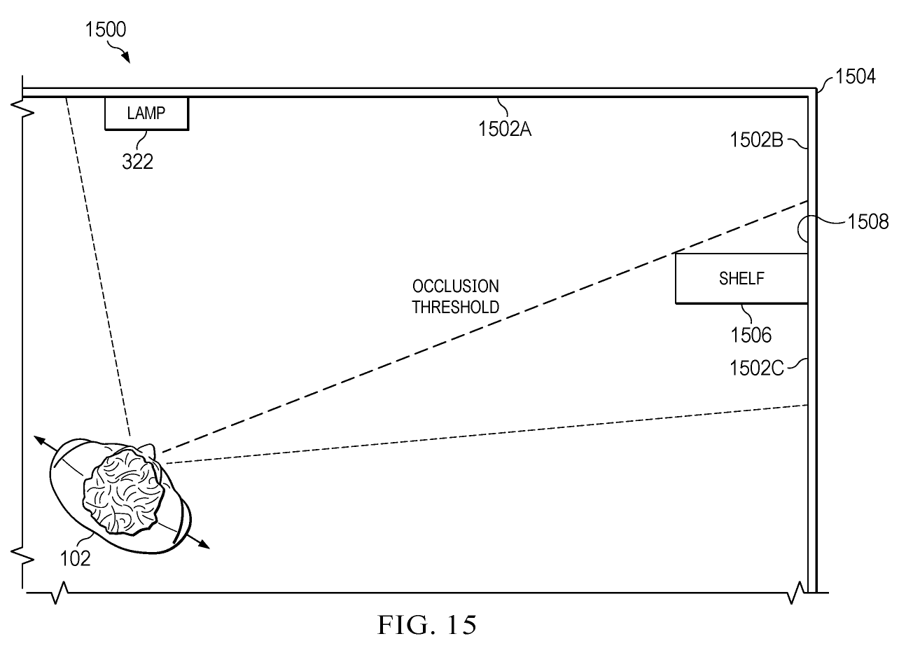

For example, FIG. 15 illustrates an environment 1500 that includes an observer 102, the lighting fixture 322, and a shelf 1506. A wall includes a first wall portion 1302A, a second wall portion 1302B, and a third wall portion 1302C. The first wall portion 1302A and the second wall portion 1302B are connected by a corner 1504. The viewing angle of the observer 102 may be tracked by the metadata controller 312 (e.g., by head tracking or eye tracking). Due to the viewing angle of the observer 102, an occluded portion 1508 of the wall is not visible to the observer 102 due to the shelf 1506. As the observer 102 moves (e.g., angularly and/or laterally), the metadata controller 312 adjusts the reflectivity of the first wall portion 1302A, the second wall portion 1302B, and/or the third wall portion 1302C so that the observer 102 sees a homogenous surface and not apparent edges.

In yet another example, the metadata controller 312 may control the reflectivity of the metadata controller 312 to emphasize or deemphasize areas or objects within an environment. For example, the reflectivity of the electrophoretic display 324 may be increased by the metadata controller 312 to add a brightly-reflecting rim around a real piece of furniture, a picture, or the like. Additionally, the metadata controller 312 may control the reflectivity of the electrophoretic display 324 to brighten certain areas of an environment to which a content creator wants to guide the attention of the observer 102. Such details may be included within the metadata 302 and established by a content creator who is creating the video content 301 and the metadata 302.

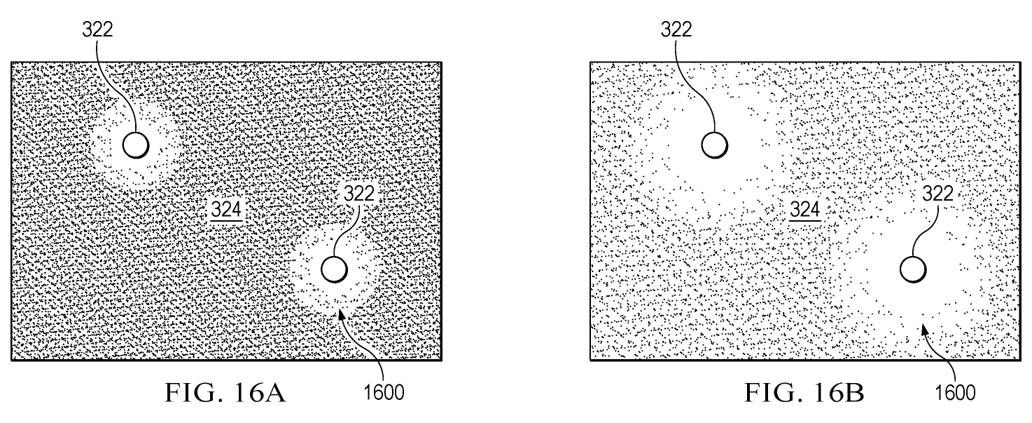

In a further example, the metadata controller 312 may control both the lighting fixture 322 and the electrophoretic display 324 to increase the perceived illuminance from the lighting fixture 322 by the observer 102. For example, FIG. 16A illustrates an example of the lighting fixture 322 projecting light with the direct surrounding electrophoretic display 324 in a low-reflectivity (or no-reflectivity) mode. As seen in FIG. 16A, the lighting fixture 322 has a PSF 1600 having a short, or small, spatial spread of diffused light. The PSF 1600 increases the visible dynamic range perceived by the observer 102, as the lighting fixture 322 appears smaller. Multiple lighting fixtures 322 may be implemented in combination with the electrophoretic display 324 to create the appearance of, for example, pin lights. In the example of FIG. 16B, the lighting fixture 322 has the same PSF 1600. However, the electrophoretic display 324 directly surrounding the lighting fixture 322 is in a high-reflectivity mode. Accordingly, while the light emitted by the lighting fixture 322 is the same, the PSF 1600 appears to be a wider spread of diffused light. Accordingly, in the example of FIG. 16B, the observer 102 may perceive each lighting fixture 322 to be larger. The electrophoretic display may also be used add texture or pattern to change the appearance of the light source (e.g. make a round light appear rectangular or like a star).

In some implementations, there is a delay in the operation of the electrophoretic display 324 when changing between states. For example, changing the reflectivity of the electrophoretic display 324 from a low reflectivity to a high reflectivity may not be instantaneous. Accordingly, the metadata 302 may include timing information describing when the reflectivity of the electrophoretic display 324 should be changed based on the video content 301. The timing information may be set by a content creator during creation of the video content 301. In other examples, the metadata controller 312 determines (e.g., computes, estimates) the timing information based on the video content 301 (for example, based on the APL value of each frame in the video content 301). In some instances, the timing information is determined or altered based on the viewing environment, including the time of day, ambient light levels, data included in the feedback data 318, data included in the observer settings 320, or the like.

By way of example, in dark and mid-luminance level content, the electrophoretic display 324 may remain dark (low reflectivity). When the content becomes high-luminance level content, the electrophoretic display 324 may be switched to highly reflective. The switching to high reflectivity of the electrophoretic display 324 may be commenced ahead of the scene change to set the reflectivity on time based on both perceptual principle (the timing of the video content 301) and technical behavior (how long the electrophoretic display 324 takes to change reflectivity).

In some instances, the electrophoretic display 324 includes multiple pixels that are individually controlled by the metadata controller 312. However, such an instance may require a large bandwidth for control of the electrophoretic display 324. Accordingly, in some implementations, the metadata controller 312 controls the electrophoretic display 324 using geometric vector information as a payload. For example, the metadata controller 312 transmits coordinates, colors, radii, and gradient information as vector or raster information to the electrophoretic display 324 to alter the reflectivity and/or color of the electrophoretic display 324 using a low bandwidth. The vector or raster information such as gradients may then be rendered by the electrophoretic display 324.

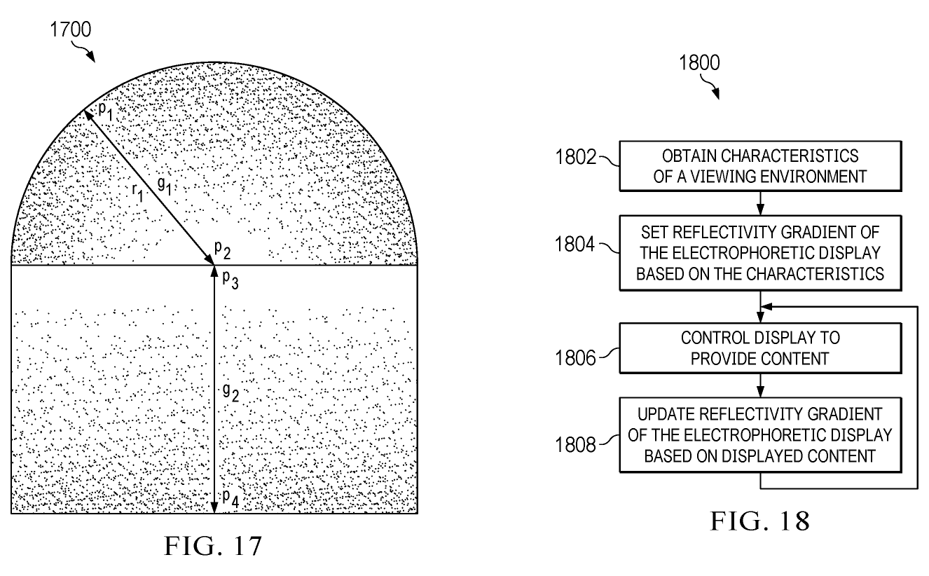

FIG. 17 illustrates example vector descriptors 1700 to transmit spatial information for the electrophoretic display 324. In the example of FIG. 17, the vector descriptors 1700 includes a radius (r1), points (p1-p4), and gradient properties (g1, g2). The gradient properties provide a change in the gradient between two points. For example, the gradient property value g2 defines how the reflectivity of the electrophoretic display 324 changes between points p3 and p4.

In one example and with reference to FIG. 4, the vector descriptors 1700 are provided within the metadata 302 from the database 402 to the metadata controller 312. The metadata controller 312 processes the vector descriptors 1700 and, with the feedback data 318 in consideration, the metadata controller 312 generates unique panel metadata to control each respective electrophoretic display 324. The metadata controller 312 transmits the panel metadata to the respective edge processor 406, and the respective edge processor 406 adjusts the reflectivity of the respective electrophoretic display 324 based on the panel metadata from the metadata controller 312.

FIG. 18 provides a flow chart of a method 1800 for controlling the electrophoretic display 324. The method 1800 may be performed by, for example, the metadata controller 312 in conjunction with the video controller 304. Additionally, the steps provided within FIG. 18 are merely examples, and may instead be conducted in a different order or simultaneously. In some examples, steps provided within FIG. 18 may be skipped or omitted.

At block 1802, the metadata controller 312 obtains characteristics of a viewing environment. For example, with reference to FIGS. 9-9, the metadata controller 312 obtains, from the feedback data 318, the position of the observer 102, the position of the lighting fixture 322, the position of the additional controllable lights 902, the position of the content display 310, dimensions of the environment 900, the location of any furniture within the environment 900, the location of any shadows, the location of any corners, and combinations thereof. In some instances, at least a portion of the characteristics of the environment 900 are included in the observer settings 320.

At block 1804, the metadata controller 312 sets a reflectivity shape or gradient of the electrophoretic display 324 based on the characteristics. For example, the metadata controller 312 generates a payload including the vector descriptors 1700 based on the received characteristics. The reflectivity gradient transmitted to the electrophoretic display 324 may control the electrophoretic display 324 to perceptually change a PSF of the lighting fixture 322, perceptually hide corners of a wall, compensate for shadow or shading changes on a wall, or the like.

At block 1806, the video controller 304 controls the content display 310 to provide content. For example, the video controller 304 receives the video content 301. The video controller 304 then provides the video content 301, or instructions representative of how to provide the video content 301, to the content display 310.

At block 1808, the metadata controller 312 updates the reflectivity gradient of the electrophoretic display 324 based on the displayed content. For example, the metadata controller 312 receives, from the metadata 302, timing information and control information regarding how the reflectivity of the electrophoretic display 324 should be set corresponding to the video content 301. The metadata controller 312 transmits control signals to the electrophoretic display 324 in accordance with the metadata 302. In another example, the metadata controller 312 receives the APL value of the content displayed by the content display 310 via the feedback data 318 and/or the observer settings 320. The metadata controller 312 transmits control signals to the electrophoretic display 324 in accordance with the APL value of the displayed content. The metadata controller 312 may return to block 1806 to further control the content display 310 to provide the video content 301 such that the metadata controller 312 continues updating the reflectivity of the electrophoretic display 324 while the video content 301 is being displayed.

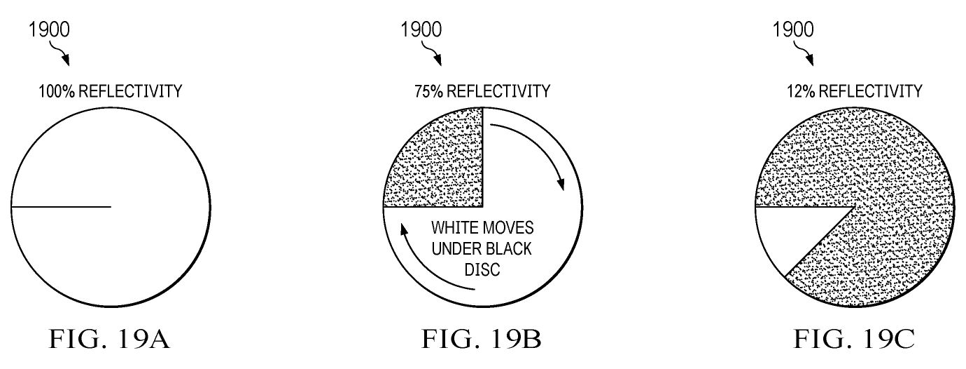

Examples described herein have primarily referred to electrophoretic displays for altering the reflectivity within viewing environments. In some implementations, the electrophoretic display 324 may be replaced with controllable liquid crystal coverings or other mechanical shutter mechanisms. For example, FIGS. 19A-19C illustrate a mechanical reflectance changing device 1900 in three different positions. The mechanical reflectance changing device 1900 includes a rotary shutter that is mechanically adjusted to reflect more or less light. In FIG. 19A, the mechanical reflectance changing device 1900 is fully open and has a reflectivity of 100%. In FIG. 19B, the mechanical reflectance changing device 1900 is 1/4 closed, providing 75% reflectivity. In FIG. 19C, the mechanical reflectance changing device 1900 is 88% closed, providing 12% reflectivity.

In other implementations, the electrophoretic display 324 may be replaced with thermochromic or electrochromic surfaces or paints that can be changed in “color” by varying the temperature or applying a voltage. Additionally, various reflectivity manipulation devices may be used in combination. For example, while some walls of a viewing environment include the electrophoretic display 324, other walls of the viewing environment may include the mechanical reflectance changing device 1900.

The reflectance directionality of the dynamic wall covering (e.g., the electrophoretic display 324) may also be controlled by the metadata controller 312. For example, a nano-tube filter sheet may be added onto the electrophoretic display 324. In another example, retro-reflective materials, metamaterials, or Fresnel lens systems may be implemented with the electrophoretic display 324 for reflectance directionality control. In yet another example, the Lambertian-ness of a reflection from diffuse to highly direction reflections may be modulated using a polymer dispersed liquid crystal (PDLC) electric film based on liquid crystals. The liquid crystals may be switched from diffuse to directional by the metadata controller 312. Flexible OLED displays may also be implemented for wall and object coverings.

While examples described herein primarily relate to changing the reflectivity of the electrophoretic display 324, in some instances, the electrophoretic display 324 may also or alternatively be controlled to depict textures. Textures may create a focal anchor point or area (e.g., 1/f noise or other natural patterns), may steer the focus of the observer 102, and may test the focal resolution of the observer 102 (e.g., via lines, gratings, etc.).

### Example Use Case

The here described approaches can be applied in a wide range of applications, including but not limited to architectural settings such as rooms, hallways, offices, as well as mobile settings such as vehicle interiors such as cars, aviation and mass transit. As an example, in a vehicle interior setting surfaces such as the roof, dashboard, seatbacks, and door panels may be constructed partly or wholly with electrophoretic display capabilities, and the electrophoretic displays may be adjusted in response to a variety of factors such as ambient lighting conditions, whether the vehicle is stationary or moving, whether the vehicle is being manually driven or driven via a self-driving mechanism, whether visual media content such as a movie is being shown on a display, etc. A second example is a home theater setting that a content viewer installed within their living room. The living room includes, among other things, a couch, a television, and walls. Electrophoretic display panels are configured to cover the walls of the living room. During the day, the electrophoretic display panels are set to a high-reflectivity mode such that ambient light is scattered throughout the living room. A controller is connected to the television and the electrophoretic display panels.

At night, the content viewer turns on the television to watch video content. In response to the television being turned on, the controller controls the electrophoretic display panels to a low-reflectivity mode. Accordingly, very little ambient light is reflected by the walls, and immersion of the content viewer viewing the video content is increased.

While watching the video content, a bright scene occurs having a high APL value. In response, the controller increases the reflectivity of the electrophoretic display panels. The bright light from the television is scattered by the walls, increasing the brightness within the living room and increasing immersion of the content viewer viewing the video content. When the bright scene ends, the controller decreases the reflectivity of the electrophoretic display panels, and light is no longer scattered by the walls.

Systems, methods, and devices in accordance with the present disclosure may take any one or more of the following configurations.

Clause 1. A viewing environment comprising: a content display configured to provide video content; a wall portion having an electrophoretic display; and a controller connected to the electrophoretic display, the controller configured to adjust a reflectivity of the electrophoretic display.

Clause 2. The viewing environment of clause 1, further comprising: a switch configured to move between a first position and a second position, wherein the controller is configured to: set the electrophoretic display to a low-reflectivity mode when the switch is in the first position, and set the electrophoretic display to a high-reflectivity mode when the switch is in the second position.

Clause 3. The viewing environment of any of clauses 1-2, further comprising: a remote control, wherein the controller is configured to adjust the reflectivity of the electrophoretic display based on a signal from the remote control.

Clause 4. The viewing environment of any of clauses 1-3, wherein the controller is configured to adjust the reflectivity of the electrophoretic display based on a statistical measure of the video content.

Clause 5. The viewing environment of clause 4, wherein the controller is configured to: receive the video content, receive metadata indicating the statistical measure of the video content at each frame of the video content and timing information for controlling the electrophoretic display at a set time interval of the video content, control the content display to provide to video content, and adjust the reflectivity of the electrophoretic display based on the statistical measure of the video content at each set time interval of the video content.

Clause 6. The viewing environment of clause 4, further comprising: a light sensor configured to detect a brightness of light emitted by the content display, wherein the controller is configured to: receive a signal from the light sensor indicative of the brightness of light emitted by the content display, and determine the statistical measure of the video content based on the signal from the light sensor.

Clause 7. The viewing environment of clause 6, wherein the light sensor is a camera.

Clause 8. The viewing environment of any of clauses 1-7, further comprising: a lighting fixture configured to project light within the viewing environment, wherein the controller is configured to: control the lighting fixture to project light when a statistical measure of the video content is greater than a threshold, and set the electrophoretic display to a high-reflectivity mode when the statistical measure of the video content is greater than the threshold.

Clause 9. The viewing environment of clause 8, wherein the controller is configured to: control the lighting fixture to an off state when the statistical measure of the video content is less than the threshold, and set the electrophoretic display to a low-reflectivity mode when the statistical measure of the video content is greater than the threshold.

Clause 10. The viewing environment of any of clauses 1-9, wherein the electrophoretic display includes a first portion and a second portion, and wherein the controller is configured to: control the first portion of the electrophoretic display to have a first reflectivity, and control the second portion of the electrophoretic display to have a second reflectivity different from the first reflectivity.

Clause 11. The viewing environment of any of clauses 1-10, wherein, to adjust the reflectivity of the electrophoretic display, the controller is configured to: generate a payload including spatial information and a gradient property, wherein the gradient property defines a change in reflectivity of the electrophoretic display between two points of the electrophoretic display, and transmit the payload to the electrophoretic display.

Clause 12. A method for controlling an electrophoretic display within a viewing environment, the method comprising: receiving an average picture level (APL) value of video content displayed within the viewing environment; and updating a reflectivity of the electrophoretic display based on the APL value.

Clause 13. The method of clause 12, wherein receiving the APL value of the video content displayed within the viewing environment includes: receiving a signal from a light sensor indicative of a brightness of the video content, and determining the APL value of the video content based on the signal from the light sensor.

Clause 14. The method of any of clauses 12-13, wherein updating the reflectivity of the electrophoretic display includes: setting the electrophoretic display to a high-reflectivity mode when the APL value of the video content is above an APL threshold, and setting the electrophoretic display to a low-reflectivity mode when the APL value of the video content is below an APL threshold.

Clause 15. The method of any of clauses 12-14, further comprising: comparing the APL value of the video content to a look-up table; and determining the reflectivity of the electrophoretic display based on the comparison of the APL value to the look-up table.

Clause 16. The method of any of clauses 12-15, wherein updating the reflectivity of the electrophoretic display includes: comparing the APL value of the video content to a first threshold, setting, in response to the APL value being less than the first threshold, the reflectivity of the electrophoretic display to a first reflectivity, and setting, in response to the APL value being greater than or equal to the first threshold, the reflectivity of the electrophoretic display to a second reflectivity.

Clause 17. The method of clause 16, further comprising: comparing the APL value of the video content to a second threshold greater than the first threshold, setting, in response to the APL value being greater than or equal to the first threshold and less than the second threshold, the reflectivity of the electrophoretic display to the second reflectivity, and setting, in response to the APL value being greater than or equal to the second threshold, the reflectivity of the electrophoretic display to a third reflectivity.

Clause 18. The method of any of clauses 12-17, wherein updating the reflectivity of the electrophoretic display based on the APL value includes updating the reflectivity of the electrophoretic display for each frame of the video content based on the APL value of the respective frame.

Clause 19. A non-transitory computer-readable medium storing instructions that, when executed by one or more processors, cause the one or more processors to perform the method of any of clauses 12-18.

Clause 20. A method for controlling an electrophoretic display within a viewing environment, the method comprising: obtaining characteristics of the viewing environment, setting a reflectivity gradient of the electrophoretic display based on the characteristics of the viewing environment, controlling a content display to provide video content, and updating the reflectivity gradient of the electrophoretic display based on the displayed content.

Clause 21. The method of clause 20, wherein the characteristics of the viewing environment include at least one selected from a group consisting of a position of an observer, a position of a lighting fixture, a position of controllable lights, a position of a projector, a position of the content display, a dimension of the viewing environment, a location of objects within the viewing environment, a location of shadows, and a location of corners.

Clause 22. The method of any of clauses 20-21, wherein setting the reflectivity gradient of the electrophoretic display includes: generating a payload including spatial information and a gradient property, wherein the gradient property defines a change in reflectivity of the electrophoretic display between two points of the electrophoretic display, wherein the two points are described within the spatial information, and transmitting the payload to the electrophoretic display.

Clause 23. The method of any of clauses 20-22, further comprising: receiving metadata associated with the video content, wherein the metadata includes timing information relating the reflectivity gradient to the video content, wherein updating the reflectivity gradient of the electrophoretic display based on the displayed content includes updating the reflectivity gradient of the electrophoretic display based on the timing information.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A viewing environment comprising:
a content display configured to provide video content;
a wall portion having an electrophoretic display; and
a controller connected to the electrophoretic display, the controller configured to adjust a reflectivity of the electrophoretic display.

2. The viewing environment of claim 1, further comprising:
a switch configured to move between a first position and a second position,
wherein the controller is configured to:
set the electrophoretic display to a low-reflectivity mode when the switch is in the first position, and
set the electrophoretic display to a high-reflectivity mode when the switch is in the second position.

3. The viewing environment of claim 1, further comprising:
a remote control,
wherein the controller is configured to adjust the reflectivity of the electrophoretic display based on a signal from the remote control.

4. The viewing environment of claim 1, wherein the controller is configured to adjust the reflectivity of the electrophoretic display based on a statistical measure of the video content.

5. The viewing environment of claim 4, wherein the controller is configured to:
receive the video content,
receive metadata indicating the statistical measure of the video content at a set time interval of the video content and timing information for controlling the electrophoretic display at each set time interval of the video content,
control the content display to provide to video content, and
adjust the reflectivity of the electrophoretic display based on the statistical measure of the video content at each set time interval of the video content.

6. The viewing environment of claim 4, further comprising:
a light sensor configured to detect a brightness of light emitted by the content display,
wherein the controller is configured to:
receive a signal from the light sensor indicative of the brightness of light emitted by the display, and
determine the statistical measure of the video content based on the signal from the light sensor.

7. The viewing environment of claim 6, wherein the light sensor is a camera.

8. The viewing environment of claim 1, further comprising:
a lighting fixture configured to project light within the viewing environment,
wherein the controller is configured to:
control the lighting fixture to project light when a statistical measure of the video content is greater than a threshold, and
set the electrophoretic display to a high-reflectivity mode when the statistical measure of the video content is greater than the threshold.

9. The viewing environment of claim 8, wherein the controller is configured to:
control the lighting fixture to an off state when the statistical measure of the video content is less than the threshold, and
set the electrophoretic display to a low-reflectivity mode when the statistical measure of the video content is greater than the threshold.

10. The viewing environment of claim 1, wherein the electrophoretic display includes a first portion and a second portion, and wherein the controller is configured to:
control the first portion of the electrophoretic display to have a first reflectivity, and
control the second portion of the electrophoretic display to have a second reflectivity different from the first reflectivity.

11. The viewing environment of claim 1, wherein, to adjust the reflectivity of the electrophoretic display, the controller is configured to:
generate a payload including spatial information and a gradient property, wherein the gradient property defines a change in reflectivity of the electrophoretic display between two points of the electrophoretic display, and
transmit the payload to the electrophoretic display.

12. A method for controlling an electrophoretic display within a viewing environment, the method comprising:
receiving an average picture level (APL) value of video content displayed within the viewing environment; and
updating a reflectivity of the electrophoretic display based on the APL value.

13. The method of claim 12, wherein receiving the APL value of the video content displayed within the viewing environment includes:
receiving a signal from a light sensor indicative of a brightness of the video content, and
determining the APL value of the video content based on the signal from the light sensor.

14. The method of claim 12, wherein updating the reflectivity of the electrophoretic display includes:
setting the electrophoretic display to a high-reflectivity mode when the APL value of the video content is above an APL threshold, and
setting the electrophoretic display to a low-reflectivity mode when the APL value of the video content is below an APL threshold.

15. The method of claim 12, further comprising:
comparing the APL value of the video content to a look-up table; and
determining the reflectivity of the electrophoretic display based on the comparison of the APL value to the look-up table.

16. The method of claim 12, wherein updating the reflectivity of the electrophoretic display includes:
comparing the APL value of the video content to a first threshold,
setting, in response to the APL value being less than the first threshold, the reflectivity of the electrophoretic display to a first reflectivity, and
setting, in response to the APL value being greater than or equal to the first threshold, the reflectivity of the electrophoretic display to a second reflectivity.

17. The method of claim 16, further comprising:
comparing the APL value of the video content to a second threshold greater than the first threshold,
setting, in response to the APL value being greater than or equal to the first threshold and less than the second threshold, the reflectivity of the electrophoretic display to the second reflectivity, and
setting, in response to the APL value being greater than or equal to the second threshold, the reflectivity of the electrophoretic display to a third reflectivity.

18. The method of claim 12, wherein updating the reflectivity of the electrophoretic display based on the APL value includes updating the reflectivity of the electrophoretic display for each frame of the video content based on the APL value of the respective frame.

19. A non-transitory computer-readable medium storing instructions that, when executed by one or more processors, cause the one or more processors to perform the method of claim 12.

20. A method for controlling an electrophoretic display within a viewing environment, the method comprising:
obtaining characteristics of the viewing environment,
setting a reflectivity gradient of the electrophoretic display based on the characteristics of the viewing environment,
controlling a content display to provide video content, and
updating the reflectivity gradient of the electrophoretic display based on the displayed content.

21. The method of claim 20, wherein the characteristics of the viewing environment include at least one selected from a group consisting of a position of an observer, a position of a lighting fixture, a position of controllable lights, a position of a projector, a position of the content display, a dimension of the viewing environment, a location of objects within the viewing environment, a location of shadows, and a location of corners.

22. The method of claim 20, wherein setting the reflectivity gradient of the electrophoretic display includes:
generating a payload including spatial information and a gradient property, wherein the gradient property defines a change in reflectivity of the electrophoretic display between two points of the electrophoretic display, wherein the two points are described within the spatial information, and
transmitting the payload to the electrophoretic display.

23. The method of claim 20, further comprising:
receiving metadata associated with the video content, wherein the metadata includes timing information relating the reflectivity gradient to the video content,
wherein updating the reflectivity gradient of the electrophoretic display based on the displayed content includes updating the reflectivity gradient of the electrophoretic display based on the timing information.
